(19) United States
(12) Patent Application Publication
(10) Pub. No.: US 2024/0198232 A1
(43) Pub. Date: Jun. 20, 2024

(54) EFFICIENT GAMEPLAY TRAINING FOR ARTIFICIAL INTELLIGENCE

(71) Applicant: GOOGLE LLC, Mountain View, CA (US)

(72) Inventors: Nathan Sun Martz, San Francisco, CA (US); Horacio Hernan Moraldo, Mountain View, CA (US); Stewart Miles, San Francisco, CA (US); Leopold Haller, Berkeley, CA (US); Hinako Sakazaki, Albany, CA (US)

(21) Appl. No.: 18/554,931

(22) PCT Filed: Apr. 11, 2022
(86) PCT No.: PCT/US2022/024192

§ 371 Date: Oct. 11, 2023

Related U.S. Application Data
(60) Provisional application No. 63/193,244, filed on May 26, 2021.

(51) Int. Cl. A63F 13/67; A63F 13/352; A63F 13/79; G06N 5/04

(52) U.S. Cl. CPC A63F 13/67; A63F 13/352; A63F 13/79; G06N 5/04

(57) ABSTRACT

Systems and methods are described for training a locally executed actor component to execute real-time gameplay actions in a gaming application based on one or more gameplay data models generated by a remote learning service. A gameplay data model for the gaming application is provided from one or more server computing systems executing the remote learning service to the client computing device. Observational data is generated by the local actor component based on in-game results of artificial gameplay actions performed by the local actor component, based at least in part on inferences generated by the actor component using the provided gameplay data model. Based on the received observational data, the remote learning service modifies the gameplay data model and provides the modified gameplay data model to the local actor component to improve future artificial gameplay actions.

### BACKGROUND

Consumer-grade graphics processing units (GPUs), widespread broadband availability, and market forces have combined to create games of considerable scope and complexity. Modern games are not just more complex than their predecessors, they reflect fundamental changes in the way games are designed and played. Simple linear indoor levels have been replaced by enormous photorealistic outdoor spaces, scripted sequences have been replaced by dynamic simulations, and proceduralism has enabled worlds with nearly limitless variety.

Despite these dramatic shifts in the way games are played, the way that they are tested has remained largely unchanged. Games are fundamentally simulations, with complex and emergent interactions between systems inside of a high-dimensional state space, which limits the utility of code-centric methodologies like unit testing. As a result, game testing is a predominantly manual process, highly dependent on humans who repeatedly play the game and look for defects. Unfortunately, these teams are no longer able to scale with the complexity of modern games, leading to delayed launches and lower quality products.

### BRIEF SUMMARY OF EMBODIMENTS

Embodiments are described herein in which a locally executed actor component is trained to execute real-time gameplay actions in a gaming application based on one or more gameplay data models generated by a remote learning service. A gameplay data model for the gaming application is provided from one or more server computing systems executing the remote learning service to the client computing device. Observational data is generated by the local actor component based on in-game results of artificial gameplay actions performed by the local actor component, based at least in part on inferences generated by the actor component using the provided gameplay data model. Based on the received observational data, the remote learning service modifies the gameplay data model and provides the modified gameplay data model to the local actor component to improve future artificial gameplay actions. Modifying the gameplay data model based on the observational data may in particular include updating the gameplay data model (e.g., in real time) using the observational data locally generated by and received from the remote client computing device.

In certain embodiments, a method may comprise providing, from one or more server computing systems to a remote client computing device and via a programmatic interface, a gameplay data model for a gaming application executing on the remote client computing device; receiving, from the remote client computing device via the programmatic interface, observational data generated from artificial gameplay actions performed within the gaming application by an actor component executing on the remote client computing device and based at least in part on inferences generated by the actor component using the provided gameplay data model; modifying, by the one or more server computing systems, the gameplay data model based on the received observational data; and providing, to the remote client computing device and via the programmatic interface, the modified gameplay data model.

The method may further comprise receiving, by the one or more server computing systems and via the programmatic interface, control information associating each of one or more output states of the gaming application with an input variable of the actor component executing on the remote client computing device. The one or more output states of the gaming application may include one or more of a group that includes a player reference position within a virtual environment of the gaming application, a position of an object relative to the player reference position within the virtual environment of the gaming application, a motion vector associated with an object relative to the player reference position within the virtual environment of the gaming application, geometry information regarding one or more aspects of the virtual environment of the gaming application, and/or one or more in-game reward indicators associated with gameplay of the gaming application.

The method may further comprise receiving, by the one or more server computing systems and via the programmatic interface, control information associating each of one or more input variables for the actor component with an action available to a human user of the gaming application.

Modifying the gameplay data model may be further based on additional observational data generated based on gameplay actions performed within the gaming application by a human user of the gaming application.

Modifying the gameplay data model based on the received additional observational data may include modifying the gameplay data model using a deep learning artificial intelligence.

The method may further comprise generating test data for the gaming application based on the artificial gameplay actions.

The method may further comprise aggregating observational data at the remote client computing device before transmitting the observational data, e.g., in the form of a batch of observational data, to the one or more server computing systems. This might reduce data traffic in the communication between the one or more server computing systems and the remote client computing device. Modifying the gameplay data model based on the received observational data may then be performed in response to the aggregation of observational data meeting at least one predefined criterion. The at least one criterion may, for example, comprise at least one of a defined duration period, a defined quantity of observational data (e.g., as measured in bytes or other quantity of measure) and an explicit request, e.g., from the one or more server computing systems, received at the remote client computing device.

In certain embodiments, a server may comprise a network interface, one or more processors, and a memory storing a set of executable instructions. The set of executable instructions may, when executed by the one or more processors, manipulate the one or more processors to generate, based at least in part on control information associating each of one or more output states of a gaming application with an input variable, a gameplay data model for the gaming application; provide via a programmatic interface the generated gameplay data model to an actor component executing on a remote client computing device; receive, from the actor component and via the programmatic interface, observational data generated from artificial gameplay actions performed within the gaming application by the actor component based on inferences generated by the actor component using the generated gameplay data model; modify the generated gameplay data model based on the received observational data; and provide, to the actor component and via the programmatic interface, the modified gameplay data model for use by the actor component in performing additional artificial gameplay actions within the gaming application.

The remote client computing device may execute an instance of the gaming application, such that the observational data is generated from artificial gameplay actions performed by the actor component within the instance of the gaming application executed by the remote client computing device.

The set of executable instructions may further manipulate the one or more processors to receive, via the programmatic interface, control information associating each of one or more output states of the gaming application with an input variable of the actor component executing on the remote client computing device. The one or more output states of the gaming application may include one or more of a group that includes a player reference position within a virtual environment of the gaming application, a position of an object relative to the player reference position within the virtual environment of the gaming application, a motion vector associated with an object relative to the player reference position within the virtual environment of the gaming application, geometry information regarding one or more aspects of the virtual environment of the gaming application, and/or one or more in-game reward indicators associated with gameplay of the gaming application.

The set of executable instructions may further manipulate the one or more processors to receive, via the programmatic interface, control information associating each of one or more input variables for the actor component with an action available to a human user of the gaming application.

The set of executable instructions may further manipulate the one or more processors to receive, via the programmatic interface, additional observational data generated from gameplay actions performed within the gaming application by a human user of the gaming application, and wherein to modify the gameplay data model is further based on the received additional observational data.

To modify the gameplay data model based on the received additional observational data may include to modify the gameplay data model using a deep learning artificial intelligence.

In certain embodiments, a client method may include receiving, by an actor component executed by one or more processors and via a programmatic interface from a machine learning component executing on one or more remote server computing systems, a gameplay data model for a gaming application; executing, by the one or more processors, an instance of the gaming application; providing, to the machine learning component and via the programmatic interface, observational data generated from artificial gameplay actions performed within the executing instance of the gaming application by the actor component based at least in part on inferences generated by the actor component using the gameplay data model; and receiving, from the machine learning component executing on the one or more remote server computing systems and via the programmatic interface, a modified gameplay data model based at least in part on the provided observational data.

The client method may further comprise performing one or more additional artificial gameplay actions based at least in part on additional inferences generated by the actor component using the modified gameplay data model.

The client method may further comprise generating test data for the gaming application based on the artificial gameplay actions.

The gameplay data model may be based at least in part on control information associating each of one or more output states of the gaming application with an input variable of the actor component. The one or more output states of the gaming application may comprise one or more of a group that includes a player reference position within a virtual environment of the gaming application, a position of an object relative to the player reference position within the virtual environment of the gaming application, a motion vector associated with an object relative to the player reference position within the virtual environment of the gaming application, geometry information regarding one or more aspects of the virtual environment of the gaming application, and/or one or more in-game reward indicators associated with gameplay of the gaming application.

The gameplay data model may be based at least in part on control information associating each of one or more output variables for the actor component with an action available to a human user of the gaming application.

The client method may further comprise generating additional observational data generated from gameplay actions performed within the gaming application by a human user of the gaming application, such that the modified gameplay data model is further based on the additional observational data.

### BRIEF DESCRIPTION OF THE DRAWINGS

The present disclosure may be better understood, and its numerous features and advantages made apparent to those skilled in the art, by referencing the accompanying drawings. The use of the same reference symbols in different drawings indicates similar or identical items.

FIG. 1 depicts an example networked game training system in accordance with some embodiments.

FIG. 2 depicts another example networked game training system in accordance with some embodiments.

FIG. 3 depicts a schematic block view of a Gameplay Trainer (GT) system implemented in accordance with one or more embodiments.

FIG. 4 is a block flow diagram illustrating an overview of an operational routine of a GT system in accordance with one or more embodiments.

### DETAILED DESCRIPTION

Embodiments of techniques described herein allow developers of gaming applications (also termed “game developers”) to utilize artificial intelligence (AI) to train executable actor components that can play and test one or more gaming applications (e.g., video games or other simulations). Such techniques, various embodiments of which may be referred to herein as the Gameplay Trainer (GT) system for ease of reference, may utilize both a software development kit (SDK) that game developers may link into gaming applications and a remote learning service that the SDK uses to train gameplay models associated with a particular gaming application. Thus, at a very high level, interactions between the game and the GT system may be similar to those between the game and a human player. The game produces output which is sent to the GT system; the GT system evaluates how to respond to that output, and sends back the artificial gameplay actions the GT system would like to perform. The game then applies these actions, produces new output, and the cycle repeats.

In certain embodiments, the Gameplay Trainer provides game developers with a remote learning service in conjunction with a locally executing artificial intelligence (AI) actor component to play and test each of one or more gaming applications using a gameplay data model. In at least some embodiments, the gameplay data model used by the locally executing actor component is generated by the GT system (via the GT learning service) based on observational data collected from artificial gameplay actions performed within the gaming application by the actor component. Thus, the GT system provides a solution tailored to various objectives of game development, including cost sensitivity, predictability, and ease of integration. Certain embodiments of the GT system thereby provide a solution that allows a game developer to quickly integrate the GT system into a gaming application and generate a useful gameplay data model.

In certain embodiments, the GT system may provide one or more application programming interfaces (APIs, which as used herein may indicate an application programming interface or any other suitable programmatic interface), such as in order to support popular frameworks and/or utilize common reference terminologies. In various embodiments, a platform-specific software development kit (SDK) may be provided in order for a game application developer to integrate use of such an API into a gaming application.

The Gameplay Trainer system provides game developers with a solution that is useful, flexible, trainable, and able to progress towards objectives more than simply ‘winning’ in a game application. As one non-limiting example, a gameplay data model for a gaming application may allow an actor component of the GT system to determine one or more areas of a game world in which it is likely that a human player of the gaming application may become unable to proceed in the game world—that is, where a human player is likely to get ‘stuck.’ As another non-limiting example, a gameplay data model may allow an actor component of the GT system to determine that one or more game world adversaries are inappropriately powered for their position in the game world—that they are either more powerful or less powerful than would be warranted by, for example, an encounter with a low- or mid-level character in a role-playing game. Thus, in certain embodiments, GT may emphasize rapid development of multiple gameplay data models for the gaming application, each associated with one or more distinct objectives in the game world. Alternatively, the GT system may develop a single gameplay data model that includes or otherwise progresses towards multiple objectives, such as objectives identified via one or more user-specified parameters provided to the GT system and/or identified by the GT system itself.

Although techniques and embodiments are described herein with respect to gaming applications, it will be appreciated that alternative embodiments may be utilized in conjunction with various simulation scenarios to generate behavioral data models and/or automated agents in other contexts (e.g., autonomous vehicles, autonomous robotics, etc.). Similarly, although techniques and embodiments are described herein with respect to gaming application testing, such behavioral data models and/or automated agents may be generated and/or utilized in other contexts (e.g., automated play agent or “bot” development, in-game autonomous companion characters, development of generalized automated agents for play with human players, etc.).

Embodiments of a GT system may provide various advantages for one or more developers desiring to test one or more aspects of their respective gaming applications. As one example, it may be advantageous for a developer to test a game running remotely. In certain embodiments a GT actor component executes locally with respect to an executing instance of a gaming application being tested by the GT system. However, the GT system enables such testing via connections to games that traverse the public internet, including the bandwidth and latency limitations that implies.

As another example, the GT system may decrease the computing resources utilized for such testing, which are typically a non-trivial expense for game developers. Although techniques described herein enable testing scale to large quantities of individual instances of a gaming application, such techniques also enable the GT system to effectively train useful AI from a single instance.

As another example, the GT system may enable testing of one or more gaming applications via native support for one or more associated gaming engines—typically large codebases that provide common, low-level services such as game physics and graphical rendering. In various embodiments, one or more SDKs associated with the GT system may be provided for each of a variety of such gaming engines (e.g., Unity, Unreal, and pure C++), as well as a precompiled library for shared logic.

In certain embodiments, the GT system may generate an initial gameplay model for a gaming application based on one or more parameters defined for that gaming application. In general, the defined parameters typically provide three types of information to the GT actor component: observations (the game-state that a player experiences at any given moment in time); actions (the logical interactions that a player can perform in the game); and rewards (an indication of how well or poorly the GT actor component is doing).

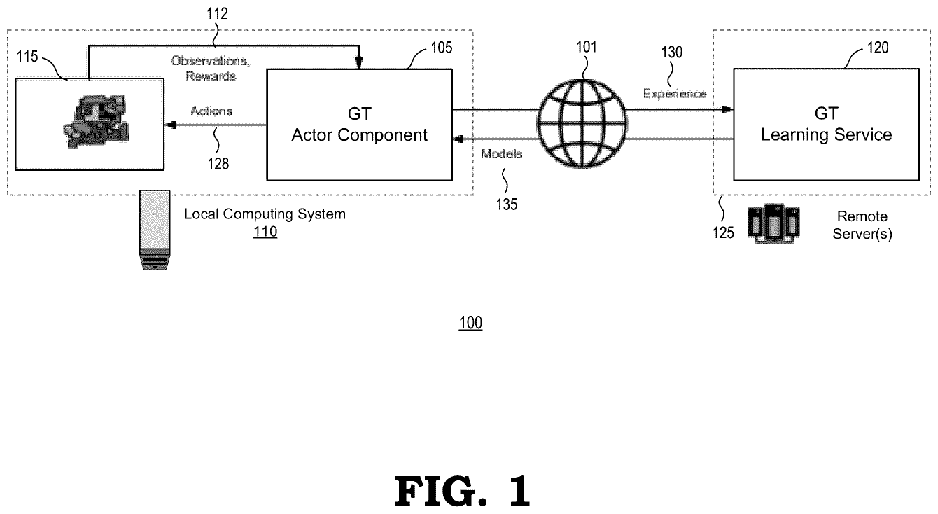

FIG. 1 depicts an example embodiment of a networked game training system 100. The networked game training system includes an instance of a GT actor component 105 executing on a local computing system 110, which is also executing a gaming application 115 that receives gameplay actions 128 from the GT actor component. The GT actor component 105 is communicatively coupled to a GT learning service 120 executing on one or more remote servers 125 via one or more computer networks 101, such as the Internet or other intervening networks. In the depicted embodiment, the GT actor component 105 generates and provides artificial gameplay actions 128 to the gaming application 115, receives observational data and in-game reward indicators 112 from the gaming application, and provides some or all of this information as observational experience data 130 to the GT learning service 120. In turn, the GT learning service 120 uses the received observational experience data 115 to generate, refine, and/or provide one or more gameplay models 135 associated with the gaming application 115 to the GT actor component 105 for improving both overall gameplay and the individual artificial gameplay actions the GT actor component provides to the gaming application.

At various points in this process, the GT system 100 (via the GT learning service 120 and/or the GT actor component 105) may generate testing data related to the gaming application 115. In certain embodiments, a game developer associated with the gaming application 115 may specify (such as via a programmatic interface of the GT learning service 120 and/or the GT actor component 105) one or more types and manners of such testing data. In addition, in certain embodiments the GT system may determine one or more aspects of testing data to generate, such as based on defined criteria stored by the GT system. In such embodiments, the defined criteria may be associated with one or more types of gaming applications to which the gaming application 115 is determined to qualify. For example, a first set of defined criteria for testing data to be generated by the GT system may be associated with a two-dimensional platforming game type, with a second set being associated with a three-dimensional platforming game type, a third set being associated with a racing game type, a fourth set being associated with an open-world role-playing game, etc.

As noted above, in certain scenarios artificial gameplay actions by the GT actor component 105 may be based at least in part on one or more gameplay data models 135 generated by the GT system 100 based on one or more parameters defined for the gaming application 115. Such parameters may be provided via a programmatic interface of the GT system 100 by (as a non-limiting example) a developer of the gaming application 115. For example, an initial gameplay model may be based on control information associating each of one or more output states of a gaming application 115 with an input variable of the GT actor component 105, and/or associating each of one or more input states for the gaming application with an output variable of the GT actor component 105. In certain embodiments, such control information may associate each of one or more of those input and/or output variables of the GT actor component 105 with an observation or action available to a human user of the gaming application. For example, an output variable of the GT actor component 105 may represent movement of a virtual character in the gaming application, with the output variable corresponding to movement of that virtual character via a physical input device that would be utilized by the human user during gameplay. Such output variables of the GT actor component 105 may correspond to any action or observation that would be available for a human user during such gameplay. In certain embodiments, the GT API allows a gaming application developer to describe inputs and outputs with high level primitives (e.g., “joystick”, “entity”, etc.) that the GT SDK then maps into GT control information, to make the API accessible without a need for the gaming application developer to exercise expertise in machine learning.

In certain embodiments, the control information may include one or more output states of the gaming application 115 for use as input variables by the GT actor component 105. As non-limiting examples, such output states may include a player reference position within a virtual environment of the gaming application 115, a position of an object relative to the player reference position within the virtual environment of the gaming application 115, a motion vector associated with an object relative to the player reference position within the virtual environment of the gaming application 115, geometry information regarding one or more aspects of the virtual environment of the gaming application 115, and/or a score or other in-game reward indicator associated with gameplay within the gaming application 115. In general, the control information may associate with a GT actor component 105 input variable any aspect of the gaming application that would be observable for a human player.

In some embodiments, the GT system 100 may also receive observational experience data resulting from gameplay actions provided to the gaming application 115 by one or more human players, such as in order to generate or modify one or more gameplay models associated with that gaming application 115 in a manner similar to that used when receiving observational experience data 130 resulting from artificial gameplay actions of the GT actor component 105. As one example, an output variable of the GT actor component 105 may allow the GT actor component 105 to indicate an assistance status within the gaming application 115, such as if the GT actor component 105 encounters an obstacle in the gaming application 115 for which the GT actor component 105 has been unable to overcome for a defined duration or quantity of attempts, the GT system 100 may initiate communication to prompt one or more human players to provide one or more gameplay actions to illustrate overcoming that obstacle. Observational experience data resulting from those human-provided gameplay actions is provided to the GT learning service 120, which then modifies the gameplay model 135 in a manner that allows the GT actor component 105 to overcome that obstacle and/or other obstacles when subsequently encountered.

One approach for training AI that can play games is Reinforcement Learning (RL). In RL, developers provide rewards for winning and penalties for losing, signals that the AI then uses to autonomously learn increasingly optimal strategies. Unfortunately, although RL has demonstrated very impressive results, RL algorithms are typically associated with high data consumption (sample in-efficient) such as millions or billions of frames of data to train players, a cost which is typically impactful for developers in terms of both time and computing resources. These algorithms also tend to have highly variable outcomes, utilizing significant domain knowledge and hyperparameter tuning in order to achieve acceptable results.

Certain embodiments therefore utilize Imitation Learning (IL) machine learning techniques, which train AI based on observing one or more human players play the game. Unlike RL, in which the agent needs to discover the optimal policy on its own, IL effectively re-creates the behavior of a human expert. Generalized IL policies perform well in scenarios that are similar, but not identical, to those captured in the human demonstrations. This problem is particularly acute in games, which are commonly built as a large number of variations (levels) on a small number of common themes (mechanics). An AI that can only learn specific variations but which cannot learn the underlying themes would not be a very effective tool.

The GT system 100 uses observations that generalize effectively. For example, egocentric observations, in which 3D information is expressed relative to the GT actor component 105's perspective instead of absolute coordinates, allow the GT learning service 120 to generate gameplay data models 135 that include movement and aiming policies independent of their training environment.

Thus, in various embodiments, the GT system 100 may determine to receive observational experience data 130 resulting from human-provided gameplay actions for refinement of a relevant gameplay model 135 based on one or more additional criteria—that is, criteria other than facing a difficult obstacle. As non-limiting examples, the GT system 100 may receive such data during regular or otherwise scheduled intervals; for all sessions or a subset of sessions associated with one or more identified human players that have elected to provide such data; for gameplay actions associated with one or more identified portions of the gaming application 115; etc.

In some embodiments, developers may provide training data to the GT learning service simply by playing the gaming application 115 in real time, with the GT learning service 120 modifying one or more gameplay models 135 and updating the GT actor component 105 accordingly. In this manner, the GT system 100 provides developers with interactive feedback regarding the quality of the GT learning service 120 and allows them to provide just-in-time corrections if and when the GT system 100 encounters a problem. In some embodiments, developers may create as many simultaneous instances of the GT actor component 105 as desired, allowing them to play and test the gaming application at scale. Moreover, in certain embodiments, the GT system 100 may evaluate multiple gameplay data models 135 based on various reward criteria, such as to determine which gameplay data model or models 135 perform better with respect to those reward criteria in-game. The GT system 100 may therefore select the best-performing gameplay data model 135 as the one to utilize for any upcoming inferences. Such automated evaluations enable the GT system 100 to “polish” trained gameplay data models.

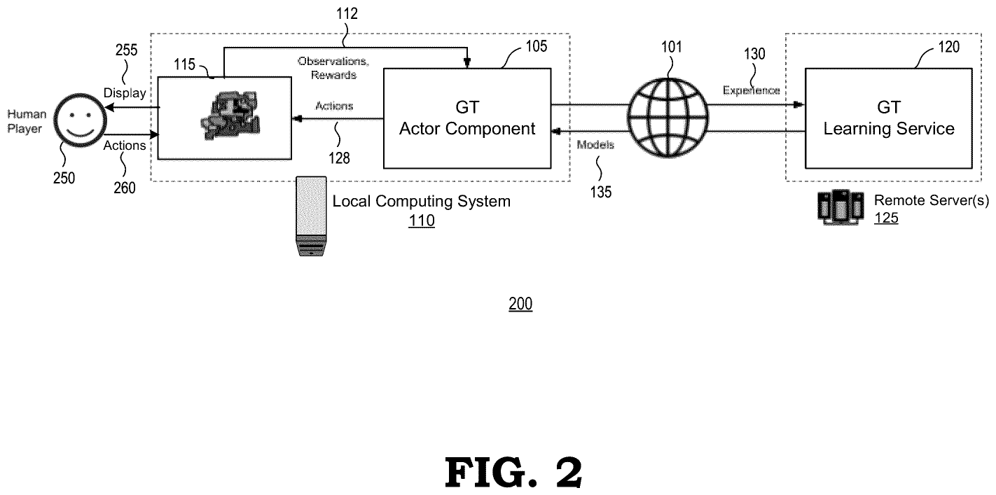

FIG. 2 depicts an example embodiment of another networked GT system 200. As with the networked system 100 of FIG. 1, the networked system 200 includes an instance of a GT actor component 105 executing on local computing system 110, which is also executing gaming application 115. The GT actor component 105 (which is communicatively coupled to GT learning service 120 via computer network(s) 101) provides artificial gameplay actions 128 to the gaming application 115, receives observational data 112 from the gaming application 115, and provides resulting observational experience data 130 to the GT learning service 120. Here, however, the gaming application 115 may receive artificial gameplay actions 128 from both the GT actor component 105 and also, at various times and in accordance with various criteria, other gameplay actions 260 from one or more human players 250, who perceive display information 255 (typically including audio, visual, tactile, and/or other perceived information) generated by the gaming application 115 in the manner of a normal gaming session. Regardless of whether the gaming application 115 receives gameplay actions from the GT actor component 105, from human player(s) 250, or both, the GT actor component 105 receives the observational data 112 from the gaming application 115 and provides the resulting observational experience data 130 to the GT learning service 120.

As noted above, in certain embodiments and implementations the GT actor component 105 may comprise a Gameplay Trainer SDK, which includes executable instructions and precompiled libraries that developers may communicatively connect (or “link”) to a gaming application 115 (such as by integrating the SDK into the program code of the gaming application), as well as an API that the developers may use to enable programmatic interactions with one or more components of the GT system 200. In certain embodiments, the GT system 200 may comprise different SDKs to support each of several popular game development frameworks, such as Unity, Unreal, and C++ (e.g., for proprietary engines). Each of these SDKs may provide the same capabilities (such as observation/action collection/transmission and on-device inference), but do so in an idiomatic way, often with language and engine-specific bindings.

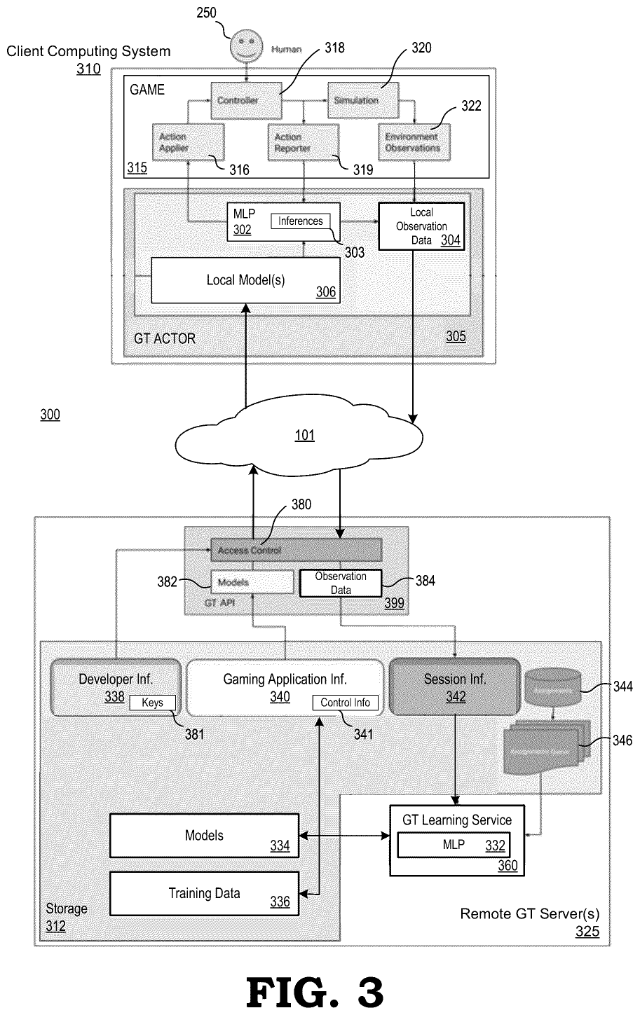

FIG. 3 depicts a schematic block view of a GT system 300 implemented in accordance with one or more embodiments. In the depicted embodiment, one or more remote GT servers 325 includes a GT API 399, a storage facility 312, and an executing instance of a GT learning service 360. A client computing system 310 is executing an instance of a gaming application 315 as well as an instance of a GT actor component 305. Each of GT server(s) 325 and client computing system 310 may be fixed or mobile, and may include instances of various computing devices such as, without limitation, desktop or other computers (e.g., tablets, slates, etc.), database servers, network storage devices and other network devices, smart phones and other cell phones, consumer electronics, gaming console systems, digital music player devices, handheld gaming devices, PDAs, pagers, electronic organizers, Internet appliances, television-based systems (e.g., using set-top boxes and/or personal/digital video recorders), and various other consumer products that include appropriate communication capabilities.

As noted elsewhere herein, the GT learning service 360 exchanges various information (e.g., authentication information, gameplay data models, observation data) with the GT actor component 305. In the illustrated embodiment, an embodiment of the GT learning service 360 executes in memory (not shown) of the remote GT server(s) 325 in order to perform at least some of the described techniques, such as by using one or more hardware processor(s) to execute software instructions of the GT learning service 360 in a manner that configures the remote GT server(s) 325 to perform automated operations that implement those described techniques. As part of such automated operations, the GT learning service 360 may store and/or retrieve various types of data, including in data structures of storage facility 312.

Storage facility 312 stores a variety of information used by the GT system 300 (and in particular, by the GT learning service 360) to generate and store gameplay data models 334 as part of providing those gameplay data models to one or more client computing systems (e.g., client computing system 310). Other information stored by the storage facility 312 includes developer information 338 (which may include access and project information regarding one or more gaming application developers); gaming application information 340 (which may include control information 341, gameplay observational data, analysis and/or evaluations of that gameplay observational data, as well as historical information regarding one or more particular gaming applications); game session information 342, and training data 336 (which may be used and stored by the GT learning service 360 as part of its generation of one or more gameplay data models 334 and for other operations). In certain implementations, the storage facility 312 may be incorporated within or otherwise directly operated by the GT system 300; in other implementations, some or all of the functionality provided by the storage facility 312 may be provided by one or more third-party network-accessible storage service providers. In certain embodiments, the GT learning service 360 also includes logic for authenticating developers and tracking meta-data about their project, such as by utilizing and modifying aspects of developer information 338.

Interactions with the GT learning service 360 (e.g., interactions by a gaming application developer and/or by client computing system 310) are performed via the GT API 399. In the depicted embodiment, the GT API 399 provides access control facilities 380, as well as the programmatic interface for passing gameplay data models 382 and observation data 384 between the remote GT servers 345 and the client computing system 310. In certain embodiments, usage of the GT system 300 may be restricted by one or more revocable API keys 381, such as may be stored as part of developer information 338 along with various other information regarding one or more projects associated with an identified developer. These keys may be used, for example, to index all data submitted by developers, including observations and gameplay actions (either artificial or generated by human players). In such embodiments, developers can only access data that they have submitted, and may further control various aspects of that data (e.g., transfer and/or deletion). Thus, in certain embodiments, API requests may require a developer to provide a valid, server-provided API key which is used for authentication, and may be used throughout interactions with the GT learning service. In this manner, the GT system 300 ensures that API calls and collected data are associated with the originating developer.

Behind the developer-facing GT API 399, the GT learning service 360 implements an Actor/Learner pattern, in which the GT actor component 305 collects and generates gameplay observations for the GT learning service 360 to transform into gameplay actions by generating and updating/modifying one or more gameplay data models associated with the gaming application 315. In the depicted embodiment, the GT actor component 305 and its machine learning platform (MLP) 302 perform various interactions with the gaming application 315 to simulate actions of a human player of the gaming application based on one or more local gameplay data models 306 that have been received from the GT learning service 360 via the GT API 399. For example, gameplay actions based on a local gameplay data model 306 may be supplied to the gaming application 315 via action applier 316, which operates a controller module 318 to simulate the execution of those gameplay actions via functions of a gaming controller that would otherwise be operated by human player 250. Those gameplay actions are reported to the MLP 302 via action reporter 319. The gameplay actions themselves result in changes to the simulation 320 via output variables (not shown) of the GT actor component 305, and additional environment observations 322 are collected as the basis for generating local observation data 304.

In various embodiments, the GT Actor component 305 may be contained by and/or generated using a GT SDK (code and precompiled libraries, not shown, that developers link into their gaming application and use to interact via the GT API 399), and performs on-device inference (e.g., using a gameplay data model to generate one or more predictions of in-game behavior and outcome as inferences 303) to collect and generate local observation data. The GT learning service 360 provides infrastructure necessary for ingesting data from the SDK, storing it via storage facility 312, training new gameplay data models 334, and serving those gameplay data models back to the GT actor component 305 via the GT API 399. In this manner, the GT SDK provides observation/action collection and on-device inference, and also acts as an adapter between the developer-facing API and the GT learning service 360. The GT learning service 360 is executed by the remote GT server(s) 325 and trains gameplay data models using a variety of algorithms. In certain embodiments, one or more of the model-training algorithms may be based on operations of a machine learning platform (MLP) 332, such as TensorFlow or other machine learning platform. Similarly, on-device inference may be performed using MLP 302 (which again may comprise TensorFlow or other machine learning platform). Local gameplay data models 306 are retrieved from the GT learning service 360, and in certain embodiments may include control information that describes how to map observations and actions into the inputs and output variables of the gameplay data model.

The GT API 399 enables gaming application developers to define parameters that describe a gaming application's logical inputs and outputs, as well as feedback on how well the AI is doing at any moment in time. Specifically, the GT system allows developers to define one or more observation parameters, action parameters, and reward parameters for each of one or more gaming applications (e.g., gaming application 315). Observation parameters (resulting in generation of observational data) describe the game-state that a player experiences at any given moment in time, which could include information like the location of visible enemies in a first-person shooting game, or the distance from the player's car to the walls of a racetrack in a racing game. Action parameters describe the logical gameplay actions that a player can take in the game, such as jumping in a platforming game or a position of the steering wheel in a racing game. Reward parameters establish one or more metrics to provide feedback regarding how well the GT actor component 305 is performing, and thus an output state of the gaming application in response to gameplay actions. In certain scenarios and embodiments, such parameters may include numerical values similar to how a player might earn points in a gaming application, but can also include other parameters. For example, a reward parameter may include an average or maximum amount of damage done by the player in an encounter, in a defined duration, or during a particular game session, as well as a simple win/lose signal at the end of a game session.

This approach allows sending all relevant output in hundreds of Kbits/s (vs tens of Mbits/s for 4K video) and allows the GT actor component 305 to focus on learning how to play the gaming application 315 without simultaneously solving a complex computer vision problem. In the process, gaming application developers are provided with more control over the data that they share with the GT learning service 360. Moreover, this approach works equally well on standalone game clients and server-based gaming applications. In addition, the GT system 300 operates without significant negative effects from the inevitable tens of milliseconds (or more) of latency between when a game sends observations and receives actions back. Such latency may be particularly problematic for alternative solutions dependent on server input for gameplay actions given that gaming applications commonly run at >30 frames per second (<33.3 ms per frame), which could easily be less time than a round trip between a server and client computing system.

In certain embodiments, the GT system 300 may operate asynchronously between the remote GT server 325 and the client computing system 310—for example, generating observation data based on one frame, advancing the simulation, and then applying one or more gameplay actions several frames later. Such asynchronous operations are leveraged by the GT system's actor/learner architecture, in which the GT actor 305 uses a gameplay data model to quickly transform gameplay observations into gameplay actions, and in which the GT learning service 360 produces new gameplay data models based on the observation data, actions, and rewards generated by the actor component and its interactions with the gaming application 315. Separating the AI operations into these two components allows the Actor component to transform gameplay observations into gameplay actions without inducing any more latency than the time to perform inferences while the GT learning service 360 leverages secure machine learning algorithms and significant amounts of compute resources.

This architecture has a number of benefits beyond avoiding the latency associated with traversing the public internet. This architecture naturally aligns with the asymmetry between training (which is very compute intensive) and inference (which can be performed on a fraction of a single CPU). By batching and compressing experience in the GT Actor component 305, the GT system 300 may reduce the associated queries per second (QPS) by ˜30× and bandwidth by ˜10×.

Games are an inherently interactive medium. Unfortunately, traditional ML workflows are anything but interactive, with minutes or hours between the submission of data and the generation of a model based on that data. The GT system 300 addresses this issue by training gameplay data models in real time. In certain embodiments, as soon as the GT learning service 360 receives observational data (whether based on actions performed by the GT actor component 305 using an existing gameplay data model or on actions performed by one or more human players), the GT learning service 360 starts training models for that data, often building off of the results from previous demonstrations and/or gameplay data models. Thanks to the compact representation of observations and actions, new gameplay data models can be generated in seconds. These gameplay data models may be constantly evaluated against submitted demonstrations by human players, such that new gameplay data models are only provided to the GT actor component 305 when they outperform the current gameplay data model in use by the GT actor component.

Thus, as described above, the GT system 300 provides gaming application developers with a training experience that is completely real-time and interactive. Although the gaming application developer is enabled to define and provide control information associating each of one or more output states of a gaming application with an input variable of the actor component executing on the client computing device, in order to train the AI, the gaming application developer may also train the AI by simply picking up a gaming controller and playing the game. After playing a few rounds of the game, the gaming application developer can put the controller down and watch the AI play the game. If the AI encounters a problematic state, the gaming application developer simply picks up the controller, demonstrates the correct behavior, and then lets the AI take control again. The result is a service that is highly experiential and controllable.

In order for the GT learning service 360 to generate gameplay data models, the GT actor component 305 periodically transmits local observation data 304 (which includes gameplay observations, actions, and rewards) to the GT learning service. When learning from demonstrations of human gameplay (such as via human player 250), this observation data is derived from the actions a human took while playing the game. In certain embodiments, this experience data may be generated by employees of the game development company, by consumer players, or some combination thereof.

After receiving a new batch of observation data, the GT API 399 generates a new assignment 344, each of which represents a request to generate a new gameplay data model. Assignments are provided to the GT learning service 360 via assignment queue 346. The GT learning service 360 includes logic necessary to combine gameplay actions, observation data, rewards and specific parameters contained in the assignment, transform them into formats understandable by MLP 332, and generate/evaluate new gameplay data models. Such gameplay data models are designed to be disposable, and in certain embodiments may express their state as resumable ML checkpoints.

Once the GT learning service 360 has completed work on an assignment, the responsively generated gameplay data model is stored as part of gameplay data models 334. The GT learning service 360 then provides the updated gameplay data model to the GT actor component 305 for use in on-device inference within the client computing system 310.

The GT Actor component 305 is able, in at least some embodiments, to perform an inference in the order of milliseconds, such as in order to support real time interactions with the developer's game. On the server side, the GT learning service 360 may in certain embodiments transform additional observation data into new gameplay data models in durations on the order of tens of seconds (such as in less than 30 seconds).

Although the individual components and modules indicated herein are provided as examples for purposes of illustrating component-level structure and certain dataflow operations, it will be appreciated that in various embodiments other arrangements of particular components and modules may effectuate the techniques presented herein.

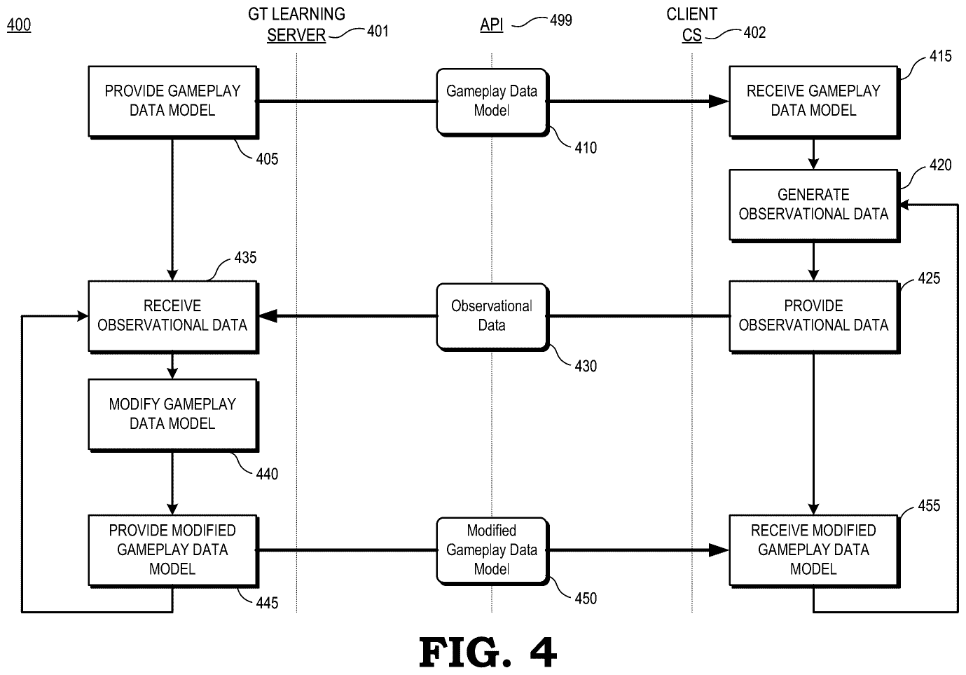

FIG. 4 is a block flow diagram illustrating an overview of an operational routine 400 of a GT system that includes operations at both a GT learning server 401 and a client computing system 402. The client computing system 402 is executing a gaming application and a GT actor component (such as GT actor component 105 of FIGS. 1 and 2 or GT actor component 305 of FIG. 3) in accordance with one or more embodiments.

The routine begins at block 405, in which the GT learning server 401 provides a gameplay data model 410 to the client computing system 402, which receives the gameplay data model at block 415 via GT API 499. As described in greater detail elsewhere herein, in certain embodiments the gameplay data model 410 initially provided by the GT learning server 401 may be based on one or more parameters defined for that gaming application, and may include a combination of game observation parameters, game action parameters (such as control information), and game reward parameters. In addition, the initial gameplay data model 410 (as well as subsequent gameplay data models) may be based at least in part on observation data generated from one or more human players.

After the gameplay data model 410 is received in block 415, the routine proceeds to block 420, in which the client computing system 402 generates observational data regarding gameplay using the gameplay data model. At block 425, the client computing system 402 provides generated observational data 430 to the GT learning server 401 via the API 499.

In certain embodiments, observation data and gameplay actions may be aggregated on client computing system 402 (such as by a GT actor component, e.g., GT actor component 305 of FIG. 3) until such information is to be provided to the GT learning service 360 in response to one or more criteria. For example, with reference to FIGS. 3, the provision of local observation data 304 (including gameplay action information) may be initiated after a defined duration period, after a defined quantity of observational data has been generated, in response to an explicit request, etc.

At block 435, the GT learning server 401 receives the observational data generated by the client computing system 402 using the gameplay data model 410, and the routine proceeds to block 440. At block 440, the GT learning server 410 modifies the gameplay data model 410 based on the newly received observational data 430.

At block 445, the GT learning server 401 provides a modified gameplay data model 450 to the client computing system 402 via API 499. At block 455, the client computing system 402 receives the modified gameplay data model 450, and returns to block 420 in order to collect and generate additional observational data based on gameplay actions using the modified gameplay data model. Similarly, after providing the modified gameplay data model 450 in block 445, the GT learning server 401 returns to block 435 to receive updated observational data from the client computing system 402.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A server method, comprising:
providing, from one or more server computing systems to a remote client computing device and via a programmatic interface, a gameplay data model for a gaming application executing on the remote client computing device;
receiving, from the remote client computing device via the programmatic interface, observational data generated from artificial gameplay actions performed within the gaming application by an actor component executing on the remote client computing device and based at least in part on inferences generated by the actor component using the provided gameplay data model;
modifying, by the one or more server computing systems, the gameplay data model based on the received observational data; and
providing, to the remote client computing device and via the programmatic interface, the modified gameplay data model.

2. The method of claim 1, further comprising receiving, by the one or more server computing systems and via the programmatic interface, control information associating each of one or more output states of the gaming application with an input variable of the actor component executing on the remote client computing device.

3. The method of claim 2, wherein the one or more output states of the gaming application include one or more of a group that includes a player reference position within a virtual environment of the gaming application, a position of an object relative to the player reference position within the virtual environment of the gaming application, a motion vector associated with an object relative to the player reference position within the virtual environment of the gaming application, geometry information regarding one or more aspects of the virtual environment of the gaming application, and/or one or more in-game reward indicators associated with gameplay of the gaming application.

4. The method of claim 1, further comprising receiving, by the one or more server computing systems, control information associating each of one or more output variables for the actor component with an action available to a human user of the gaming application.

5. The method of claim 1, wherein modifying the gameplay data model is further based on additional observational data generated based on gameplay actions performed within the gaming application by a human user of the gaming application.

6. The method of claim 5, wherein modifying the gameplay data model based on the additional observational data includes modifying the gameplay data model using a deep learning artificial intelligence.

7. The method of claim 1, further comprising generating test data for the gaming application based on the artificial gameplay actions.

8. The method of claim 1, further comprising modifying the gameplay data model based on the received observational data in response to having received an aggregation of observational data meeting at least one predefined criterion.

9. The method of claim 8, wherein the at least on criterion comprises at least one of a defined duration period, a defined quantity of observational data and an explicit request received at the remote client computing device.

10. (canceled)

11. (canceled)

12. A server, comprising:
a network interface;
one or more processors; and
a memory storing a set of executable instructions, the set of executable instructions to manipulate the one or more processors to:
generate, based at least in part on control information associating each of one or more output states of a gaming application with an input variable, a gameplay data model for the gaming application;
provide, via a programmatic interface, the generated gameplay data model to an actor component executing on a remote client computing device;
receive, from the actor component and via the programmatic interface, observational data generated from artificial gameplay actions performed within the gaming application by the actor component based on inferences generated by the actor component using the generated gameplay data model;
modify the generated gameplay data model based on the received observational data; and
provide, to the actor component and via the programmatic interface, the modified gameplay data model for use by the actor component in performing additional artificial gameplay actions within the gaming application.

13. The server of claim 12, wherein the remote client computing device executes an instance of the gaming application, and wherein the observational data is generated from artificial gameplay actions performed by the actor component within the instance of the gaming application executed by the remote client computing device.

14. The server of claim 12, wherein the set of executable instructions is further to manipulate the one or more processors to receive, via the programmatic interface, control information associating each of one or more output states of the gaming application with an input variable of the actor component executing on the remote client computing device.

15. The server of claim 14, wherein the one or more output states of the gaming application include one or more of a group that includes a player reference position within a virtual environment of the gaming application, a position of an object relative to the player reference position within the virtual environment of the gaming application, a motion vector associated with an object relative to the player reference position within the virtual environment of the gaming application, geometry information regarding one or more aspects of the virtual environment of the gaming application, and/or one or more in-game reward indicators associated with gameplay of the gaming application.

16. The server of claim 12, wherein the set of executable instructions is further to manipulate the one or more processors to receive, via the programmatic interface, control information associating each of one or more output variables for the actor component with an action available to a human user of the gaming application.

17. The server of claim 12, wherein the set of executable instructions is further to manipulate the one or more processors to receive, via the programmatic interface, additional observational data generated from gameplay actions performed within the gaming application by a human user of the gaming application, and wherein to modify the gameplay data model is further based on the received additional observational data.

18. The server of claim 17, wherein to modify the gameplay data model based on the received additional observational data includes to modify the gameplay data model using a deep learning artificial intelligence.

19. A method, comprising:
receiving, by an actor component executed by one or more processors and via a programmatic interface from a machine learning component executing on one or more remote server computing systems, a gameplay data model for a gaming application;
executing, by the one or more processors, an instance of the gaming application;
providing, to the machine learning component and via the programmatic interface, observational data generated from artificial gameplay actions performed within the executing instance of the gaming application by the actor component based at least in part on inferences generated by the actor component using the gameplay data model; and
receiving, from the machine learning component executing on the one or more remote server computing systems and via the programmatic interface, a modified gameplay data model based at least in part on the provided observational data.

20. The method of claim 19, further comprising performing one or more additional artificial gameplay actions based at least in part on additional inferences generated by the actor component using the modified gameplay data model.

21. The method of claim 19, further comprising generating test data for the gaming application based on the artificial gameplay actions.

22. The method of claim 19, wherein the gameplay data model is based at least in part on control information associating each of one or more output states of the gaming application with an input variable of the actor component.

23. The method of claim 22, wherein the one or more output states of the gaming application include one or more of a group that includes a player reference position within a virtual environment of the gaming application, a position of an object relative to the player reference position within the virtual environment of the gaming application, a motion vector associated with an object relative to the player reference position within the virtual environment of the gaming application, geometry information regarding one or more aspects of the virtual environment of the gaming application, and/or one or more in-game reward indicators associated with gameplay of the gaming application.

24. The method of claim 19, wherein the gameplay data model is based at least in part on control information associating each of one or more output variables for the actor component with an action available to a human user of the gaming application.

25. The method of claim 19, further comprising generating additional observational data generated from gameplay actions performed within the gaming application by a human user of the gaming application, such that the modified gameplay data model is further based on the additional observational data.

26. (canceled)

27. (canceled)
